(19) United States
(12) Patent Application Publication
(10) Pub. No.: US 2026/0176065 A1
(43) Pub. Date: Jun. 25, 2026

(54) BUFFERING, SORTING, CONSOLIDATION AND STORING FOR AUTOMATED STORAGE AND RETRIEVAL SYSTEM

(71) Applicant: DESIGN & ASSEMBLY CONCEPTS, INC., LEANDER, TX (US)

(72) Inventors: Dillon E. GANNINGER, Georgetown, TX (US); Mark E. GANNINGER, Leander, TX (US)

(21) Appl. No.: 19/429,199

(22) Filed: Dec. 22, 2025

Related U.S. Application Data
(60) Provisional application No. 63/738,140, filed on Dec. 23, 2024.

(51) Int. Cl. B65G 1/04; B65G 1/02; B65G 1/06

(52) U.S. Cl. CPC B65G 1/0485; B65G 1/026; B65G 1/045; B65G 1/065

(57) ABSTRACT

A tote content management system can include a robot configured to transport a tote between locations in the system, and a hopper having a variable area opening. The hopper is configured to match the opening to an area of a tote compartment. The robot is further configured to place the tote compartment under the hopper opening. Another tote content management system can include a robot configured to transport a tote between locations in the system, and a container picker configured to pick up a container and release the container into a tote. The robot may be further configured to transport the tote between the container picker and a rack.

### CROSS-REFERENCE TO RELATED APPLICATION

This application claims the benefit of the filing date of U.S. provisional application No. 63/738,140 filed on 23 Dec. 2024, the entire disclosure of which is incorporated herein by this reference for all purposes.

### BACKGROUND

This disclosure relates generally to automated storage and retrieval systems and, in some examples described below, more particularly provides for buffering, sorting, consolidating and storing items in totes.

Automated storage and retrieval systems (ASRS) are typically used in warehouses to store and retrieve containers (e.g., referred to by those skilled in the art as totes) with little or no human physical participation in the storing or retrieving. An ASRS can enhance safety, efficiency, speed and effectiveness in warehouse operations.

Therefore, it will be readily appreciated that improvements are continually needed in the art of automated storage and retrieval systems. The present disclosure provides such improvements, which improvements may be used in a wide variety of different warehouse (or other storage facility) configurations and operations.

### BRIEF DESCRIPTION OF THE DRAWINGS

FIG. 1 is a representative top view of an example of a tote content management system and associated method which can embody principles of this disclosure.

FIG. 2 is a representative top perspective view of the FIG. 1 system and method.

FIG. 3 is a representative perspective view of a portion of the FIG. 1 system and method.

FIG. 4 is a representative top view of another example of the system and method.

FIG. 5 is a representative perspective view of examples of a hopper, container handling robot and tote handling robot of the system.

FIGS. 6A & B are representative perspective and top views, respectively, of the hopper in a first configuration.

FIGS. 7A & B are representative perspective and top views, respectively, of the hopper in a second configuration.

FIGS. 8A & B are representative perspective and top views, respectively, of the hopper in a third configuration.

FIG. 9 is a representative top view of another example of the system and method.

FIG. 10 is a representative perspective view of the FIG. 9 system and method.

FIG. 11 is a representative perspective view of an example of a container picker of the FIGS. 9 & 10 system and method.

FIGS. 12A-C are representative perspective views of a series of steps performed by the container picker.

FIGS. 13A-C are representative perspective views of a series of steps performed by a container handling robot and the container picker of the FIGS. 9 & 10 system and method.

FIG. 14 is a representative perspective view of a tote handling robot storing or retrieving a tote in/from a rack.

FIG. 15 is a representative schematic view of an example of a control system that may be used with any of the systems and methods.

### DETAILED DESCRIPTION

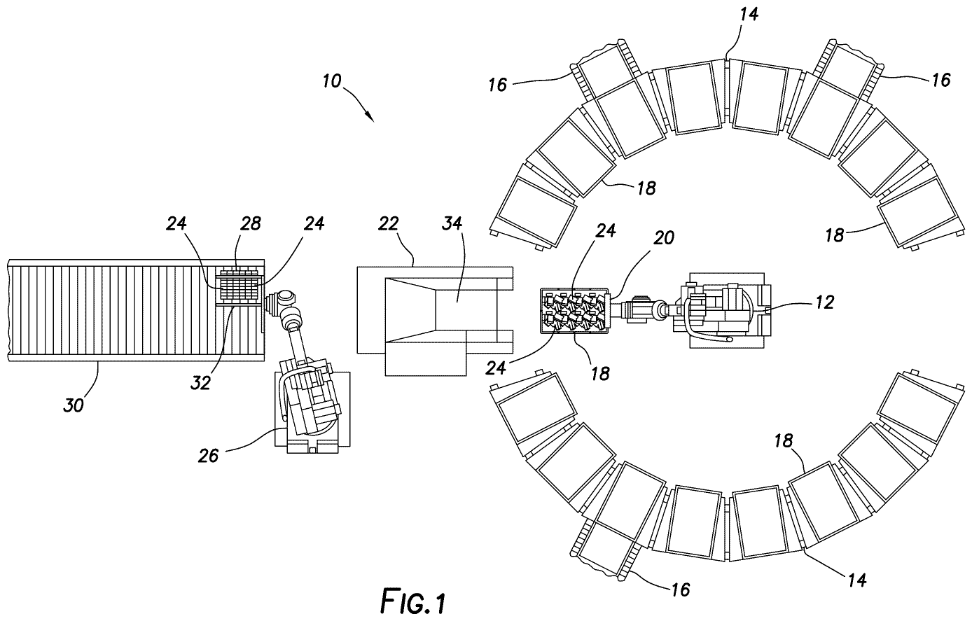

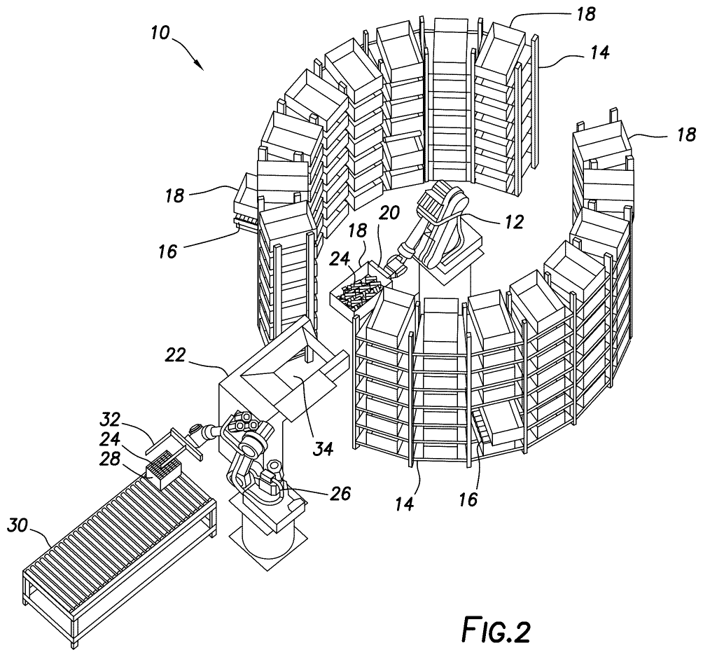

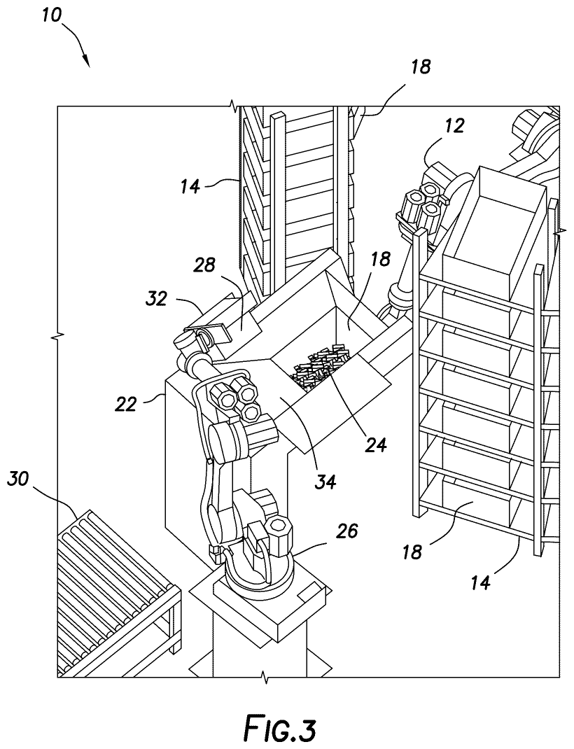

Representatively illustrated in FIGS. 1-15 are examples of a tote content management system 10 and associated method which can embody principles of this disclosure. However, it should be clearly understood that the system 10 and method are merely examples of an application of the principles of this disclosure in practice, and a wide variety of other examples are possible. Therefore, the scope of this disclosure is not limited at all to the details of the system 10 and method described herein and/or depicted in the drawings.

This disclosure in one example relates to a unique buffer/sorter or tote content management system for an automated storage and retrieval system (ASRS). The buffer/sorter efficiently handles totes containing products, with capabilities for compartmentalized storage and dynamic sorting. The system can consolidate smaller like products into a larger storage tote, thereby maximizing the storage density of a warehouse storage system. The system can streamline the process of storing, sorting, consolidating and retrieving products into and from compartmentalized totes.

The system can be configured to handle various tote sizes and configurations. The totes can be standard totes that only remain in the tote content management system or they can be totes from the ASRS. The system can be configured to handle totes with dividers, which allow multiple different products to be stored in a same tote.

The system can utilize a rotary or linear racking system for the storage of totes, with conveyors or load bays for transfer of totes into and out of the system. The system in one example utilizes a robot with a tote handling end of arm tool to allow for picking of the totes from the rack and presenting to a hopper.

In some examples, product can be transferred from a container for the product and into one or more tote compartments. A hopper depicted in the drawings has independently controlled wall and partition to change a size of an opening to match a tote compartment size. The wall and partition can be actuated, for example, pneumatically or electrically. A robot is utilized to pick the containers from a conveyor or load port.

In some examples, a containers are placed directly into totes to allow for consolidation of products, as well as to have a common size container to utilize in warehouse storage racking or ASRS. These containers can already be opened by an external opening device or they could still be sealed.

In one example, a container is conveyed to a hard stop. A size of the container is measured with a camera, scanner or other sensor to determine the size of the container. An overhead gripper grips the container and lifts the container from the conveyor.

A robot has a camera, scanner or other sensor to scan the tote interior to determine where the container can be placed in the tote. The robot moves the tote underneath the container and the gripper releases the container into the tote. The tote is then returned to a rack or transferred to an outbound conveyor.

Example components of the system can include: 1) A servo, stepper or pneumatic end of arm tooling to pick and place totes in the rack, pick and place onto conveyors, and present to the product presentation device. This end of arm tool is mounted to a robot. 2) A tote with optional dividers to create multiple compartments for holding product. 3) Linear or circular racking or shelving to store totes for buffering and storage. 4) A servo, stepper or pneumatic container gripper that can comprise clamp arms, and linear rails to allow for gripping the container to pick it from a conveyor and dump it into a hopper. This gripper is mounted to a robot. 5) A hopper mounted near the rack and tote handling robot. The hopper has a side wall and a partition that can be actuated with pneumatic or electric actuators. The side wall and partition can be automatically adjusted for the size of the compartment in the tote, so the product will only fall into the selected compartment. 6) Instead of items 4) & 5) above, one or more cameras, scanners or other sensors measure the incoming container size. An overhead gripper has electric or pneumatic gripper arms that adjust to the container size. The gripper arms can be adjusted to a length and width of the container. A vertical actuator lifts the container from a conveyor, and then lowers the container into the tote. Another camera, scanner or other sensor scans an interior of the tote before and after loading. More, fewer or different combinations of components may be used in other examples.

Potential use cases for the system include industries requiring precise inventory management and rapid product sorting, such as e-commerce fulfillment centers, warehouses and manufacturing plants. The ability to consolidate, buffer, and sort products makes the system an excellent option for users to maximize floor space and minimize labor. Other use cases are possible in other examples.

One example of an automated system and method for buffering, consolidating, sorting and storing products described herein can comprise: a robot for handling totes with variable compartments, a conveyor for transporting product boxes, a product identification system to scan and relay product identifications, a scanning system for verifying tote contents, a robot for handling product containers, and a system for transferring product from a conveyor in-feed system to product totes.

Totes may include one-compartment, two-compartment, or four-compartment configurations, with adjustable dividers to create compartments dynamically. Other numbers of compartments may be used in other examples.

The system may comprise a hopper and a robot for transferring products from containers to totes. The products may be dropped by the robot from a container, through an opening in the hopper, and into a tote.

A database may track locations or respective totes and quantities of products in totes. The system may comprise integration capabilities with automated storage and retrieval systems (such as, Autostore or Ocado). A robot may retrieve, verify, and restock totes dynamically based on product demand.

The products may be transferred from a conveyor to a tote utilizing a hopper dump system. Moveable wall and partition in a hopper may automatically adjust to various tote compartment sizes. A robot holding a tote may position a selected tote compartment underneath the hopper opening.

The products may be transferred from a conveyor to a tote utilizing a product picking mechanism. A scanner may determine a container size to be picked. A gripping system may adjust to the container size based off the container scanner and pick it off of the conveyor.

A scanner may determine a size of an empty space in a tote presented by the robot. The robot may position the tote underneath the product picking mechanism based on the size of the container.

Referring specifically now to FIGS. 1 & 2, representative top and perspective views of an example of the tote content management system 10 and associated method which can embody the principles of this disclosure are depicted. In this example, a tote handling robot 12 is positioned at a center of two arcuate buffer/storage racks 14 having one or more conveyors 16 connected thereto for transporting totes 18 to or from the system 10.

The robot 12 is preferably a conventional six-axis robot. The robot 12 in the FIGS. 1 & 2 example includes an end of arm tool 20 which permits the robot to transport totes 18 between locations in the system 10.

As depicted in FIGS. 1 & 2, the robot 12 can transport totes 18 between positions in the racks 18, between the racks and the conveyors 16, between a hopper 22 and the racks, or between the hopper and the conveyors. The robot 12 may be used to transport the totes 18 between other positions or locations in the system 10 in other examples.

The hopper 22 is used to aid in dispensing items 24 into the totes 18. The items 24 may be separate individual parts, components, products, etc., or the items could comprise packages or containers containing one or more individual parts, components, products, etc.

A container handling robot 26 (such as, a six-axis robot) is used to dump items 24 from a container 28 into the hopper 22. The container 28 is transported to a position near the robot 26 by a conveyor 30.

Although a rectangular container 28 is depicted in the drawings, in other examples the container could have a cylindrical, spherical or other shape. The scope of this disclosure is not limited to use of any particular container shape.

The robot 26 includes an end of arm tool 32 to grip the container 28, so that the robot can transport the container from the conveyor 30 to a position above an opening 34 in the hopper 22, and can turn the container over, whereby the items 24 fall from the container into the hopper opening. The robot 12 transports a tote 18 to a position under the hopper opening 34 prior to the robot 26 dumping the items 24 into the hopper 22.

If the tote 18 includes multiple interior compartments, the robot 12 can position a selected empty (or less than full) compartment of the tote 18 under the hopper opening 34, so that the items 24 will fall into the selected compartment. The size or area of the opening 34 can be adjusted to match the size or area of the selected compartment, so that the items 24 will fall only into the selected compartment. For example, the area of the opening 34 could be adjusted so that it has the same area and shape as the selected compartment, or so that the area of the opening is somewhat smaller than the area of the selected compartment (e.g., to ensure that the items 24 fall only into the selected compartment).

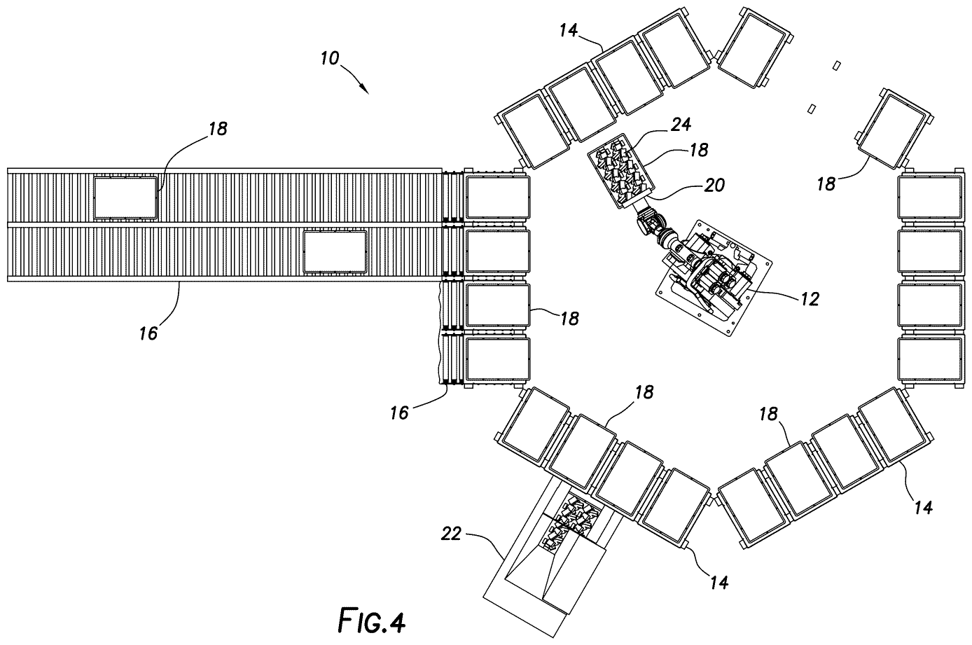

Referring additionally now to FIG. 3, a representative perspective view of a portion of the FIGS. 1 & 2 system 10 and method is depicted. In this view, the manner in which the robot 26 and end of arm tool 32 are used to position the container 28 over the hopper 22 and turn the container over, so that the items 24 fall through the opening 34, can be seen.

As depicted in FIG. 3, the robot 12 has positioned a tote 18 below the opening 34 prior to the robot 26 dumping the items 24 from the container 28 into the tote. In this example, the tote 18 has only one compartment and the opening 34 is appropriately sized to direct the items 24 into that compartment.

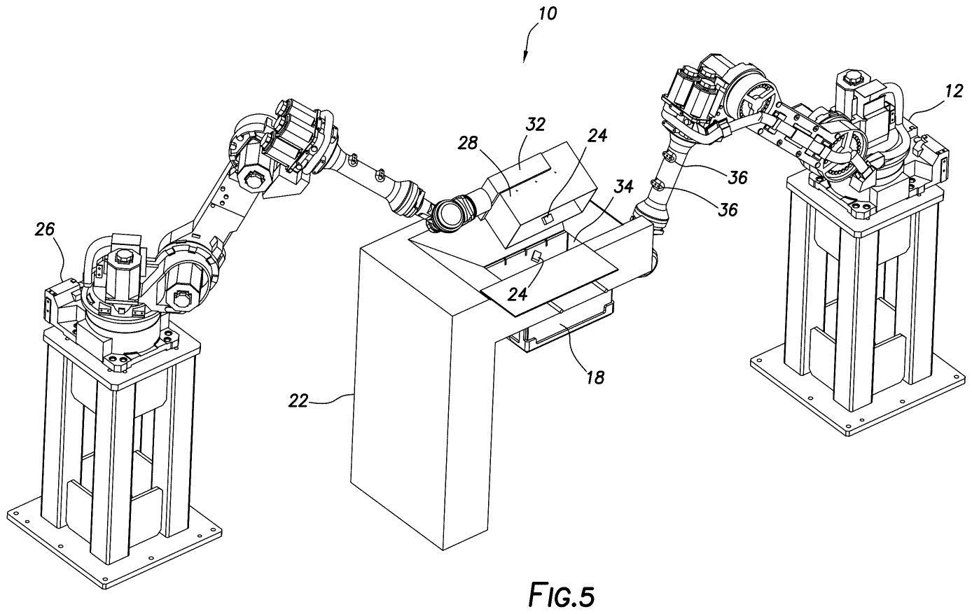

Referring additionally now to FIG. 4, a representative top view of another example of the system 10 and method is depicted. In this example, the racks 14 are linear in shape, instead of arcuate, but the racks are arranged in a somewhat circular array about the robot 12. In addition, the conveyors 16 are arranged on one side of the robot 12 for transporting totes 18 to and from the system 10.

The robot 26 and conveyor 30 are not depicted in FIG. 4, but preferably the robot 26 and conveyor 30 are used in the FIG. 4 example to convey the items 24 to the hopper 22. Note that a tote 18 is transported to and from the hopper 22 by the robot 12 through one of the racks 14 in this example.

Referring additionally now to FIG. 5, a representative perspective view of the hopper 22, container handling robot 26 and tote handling robot 12 of the system 10 is depicted. In this view, the robot 12 has transported a tote 18 to a position under the opening 34 of the hopper 22. The robot 26 has then turned the container 28 over, so that the items 24 fall from the container 28 into the tote 18 via the opening 34.

One or more sensors 36 of the robot 12 can be used to scan the interior of the tote 18 to, for example, determine whether the interior of the tote 18 is divided into separate compartments, and which of those compartments are empty or less than full. The area of the opening 34 is adjusted to match the area of a selected compartment, and the robot 12 positions the selected compartment under the adjusted opening, prior to the robot 26 dumping the items 24 from the container 28 into the hopper 22.

The sensors 36 may comprise any sensors capable of scanning the tote 18 interior. For example, the sensors 36 may be cameras, light detection and ranging (LiDAR) sensors, ultrasonic scanners, etc. The scope of this disclosure is not limited to use of any particular type of sensor to scan the interior of a tote.

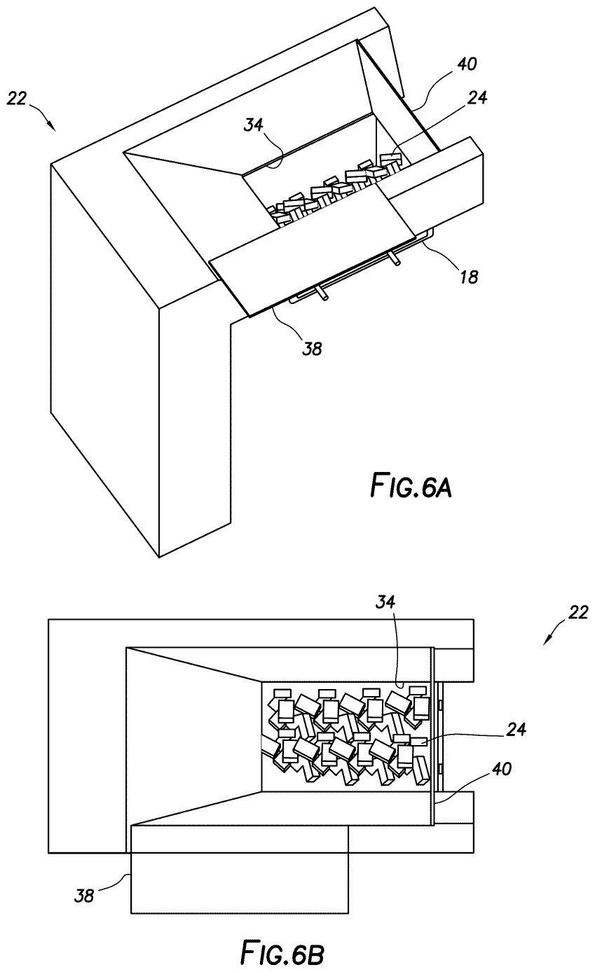

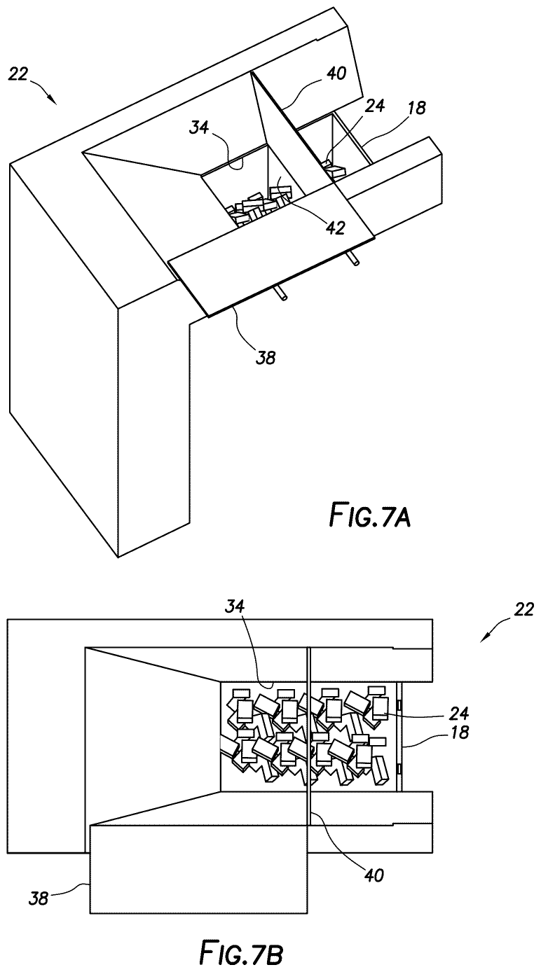

Referring additionally now to FIGS. 6A & B, representative perspective and top views, respectively, of the hopper 22 in a first configuration are depicted. In this configuration, the tote 18 interior is not divided into multiple separate compartments, but is instead a single compartment.

The robot 12 used to position the tote 18 beneath the opening 34 is not depicted in FIGS. 6A & B. However, as described above, preferably the robot 12 positions the tote 18 under the opening 34 prior to the items 24 being dropped through the opening.

Note that the opening 34 is bounded on two sides by movable walls 38, 40. The walls 38, 40 can be displaced (for example, by servo or stepper motors, pneumatic actuators, etc.) as needed to adjust the area of the opening 34 to match the area of the tote 18 compartment into which the items 24 are to be dispensed. In the FIGS. 6A & B example, the walls 38, 40 are displaced fully outward, so that the opening 34 has a maximum area, since the interior of the tote 18 comprises only a single compartment.

Referring additionally now to FIGS. 7A & B, representative perspective and top views, respectively, of the hopper 22 in a second configuration are depicted. In this configuration, the interior of the tote 18 is divided into two compartments by a divider 42 positioned in the tote.

The wall 40 is displaced inward, so that the area of the opening 34 matches the area of a selected one of the compartments (for example, a compartment identified as one that is empty or less than full, using the sensors 36 of the robot 12). The robot 12 positions the selected compartment under the adjusted opening 34, and then the items 24 are dropped through the opening into the selected compartment.

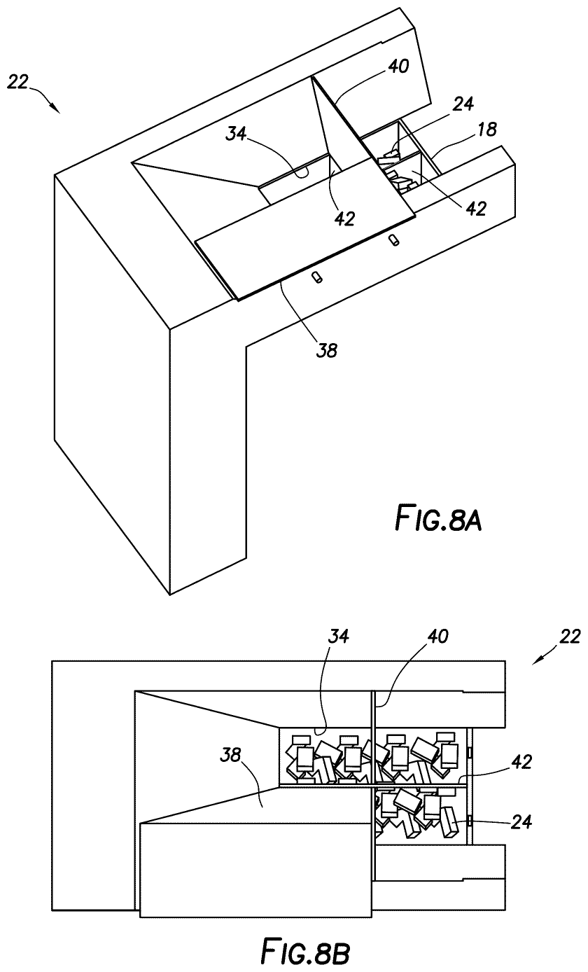

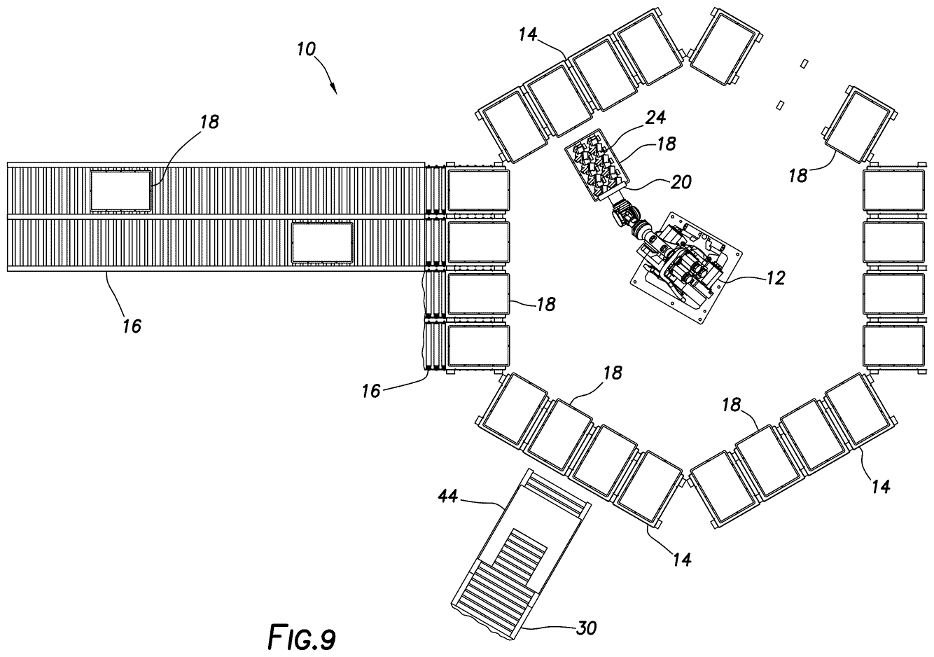

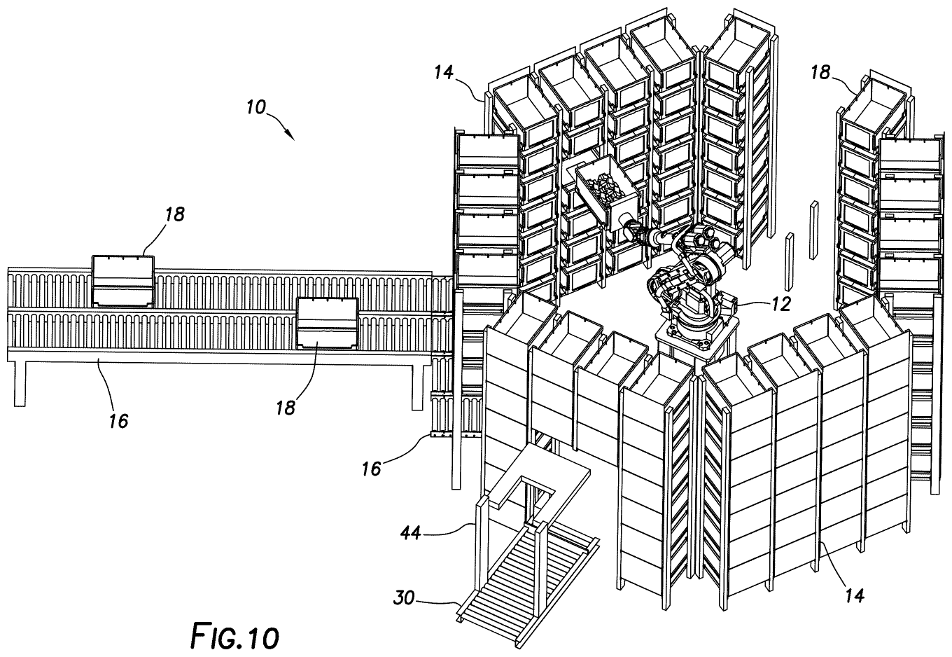

Referring additionally now to FIGS. 8A & B, representative perspective and top views, respectively, of the hopper 22 in a third configuration are depicted. In this configuration, the interior of the tote 18 is divided into four compartments by dividers 42 positioned in the tote.

The walls 38, 40 are displaced inward, so that the area of the opening 34 matches the area of a selected one of the compartments (for example, a compartment identified as one that is empty or less than full, using the sensors 36 of the robot 12). The robot 12 positions the selected compartment under the adjusted opening 34, and then the items 24 are dropped through the opening into the selected compartment.

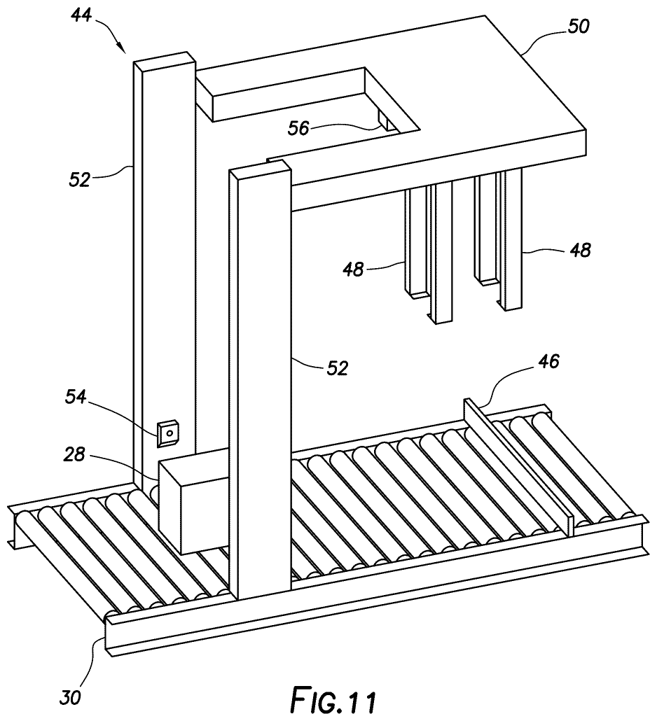

Referring additionally now to FIGS. 9 & 10, representative top and perspective views of another example of the system 10 and method are depicted. The FIGS. 9 & 10 example is similar in many respects to the FIG. 5 example. However, the FIGS. 9 & 10 example of the system 10 does not include the container handling robot 26 or the hopper 22. Instead, a container picker 44 is used to take a container 28 transported by the conveyor 30 to the container picker, and to present the container to the robot 12 as described more fully below.

The robot 12 positions a tote 18 under the container 28 after the container picker 44 has lifted the container from the conveyor 30. The container picker 44 then lowers the container 28 into the tote 18 and releases the container. The robot 12 can then store the tote 18 (with the container 28 therein) in the rack 14, or deliver the tote to one of the conveyors 16.

The sensors 36 of the robot 12 can be used to identify an empty space in the tote 18 appropriately sized to receive the container 28 therein. The robot 12 can then position the identified empty space under the container 28 after it is lifted by the container picker 44. In this manner, multiple containers 28 can be placed in the interior of a single tote 18 to maximize storage density. Alternatively, only a single container 28 may be placed in an interior of a tote 18.

Referring additionally now to FIG. 11, a representative perspective view of an example of the container picker 44 of the FIGS. 9 & 10 system 10 and method is depicted. The container picker 44 is shown in FIG. 11 as being mounted on the conveyor 30, which transports the container 28 to the system 10.

As depicted in FIG. 11, a stop plate 46 is also mounted on the conveyor 30, so that the container 28 will stop at a known position relative to the container picker 44. The known position in this example is below arms 48 that extend downward from a carriage 50 of the container picker 44. The carriage 50 is vertically displaceable along uprights or rails 52 extending upward from the conveyor 30.

A sensor 54 can scan the container 28 as it passes between the rails 52 to determine the dimensions of the container. Distances between the arms 48 can then be adjusted, so that the arms can grip or hold the container 28 as it is lifted from the conveyor 30. For example, after the container 28 has been scanned by the sensor 54, the arms 48 can be adjusted so that a width between the arms is somewhat greater than a width of the container. To grip or hold the container 28, the width between the arms 48 can then be decreased.

To release the container 28 into a tote 18, the width between the arms 48 can be increased. A sensor 56 can scan the interior of the tote 18 after the container 28 is placed in the tote, in order to verify the placement of the container into the tote. Note that the sensors 54, 56 may be the same type as, or different from, the sensors 36 of the robot 12.

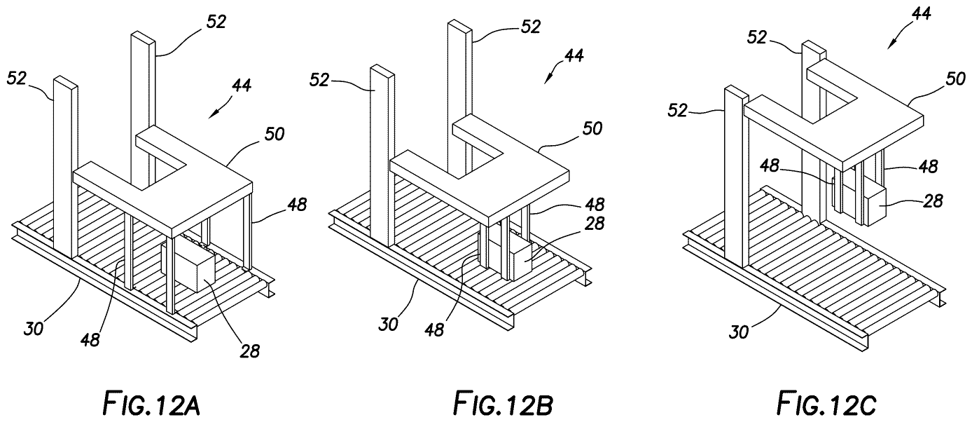

Referring additionally now to FIGS. 12A-C, representative perspective views of a series of steps performed by the container picker 44 are depicted. In these views, the container 28 is lifted from the conveyor 30. An opposite series of steps may be used to lower the container 28 into a tote 18.

In FIG. 12A, the container 28 is positioned on the conveyor 30 under the carriage 50. A distance or width between the arms 48 is greater than a width of the container 28 (as determined, e.g., using the sensor 54). The carriage 50 is lowered to position the arms 48 on opposite sides of the container 28.

In FIG. 12B, the width between the arms 48 is decreased, so that the arms now grip or hold the container 28. For example, the arms 48 could include gripping surfaces that grip the sides of the container 28, or the arms could include shoulders or shelves that are positioned under the container 28 to support the container as it is raised.

In FIG. 12C, the carriage 50 is raised along the rails 52, so that the container 28 is lifted from the conveyor 30. In this configuration, the container 28 is presented to the robot 12, so that the container can be placed in a tote 18.

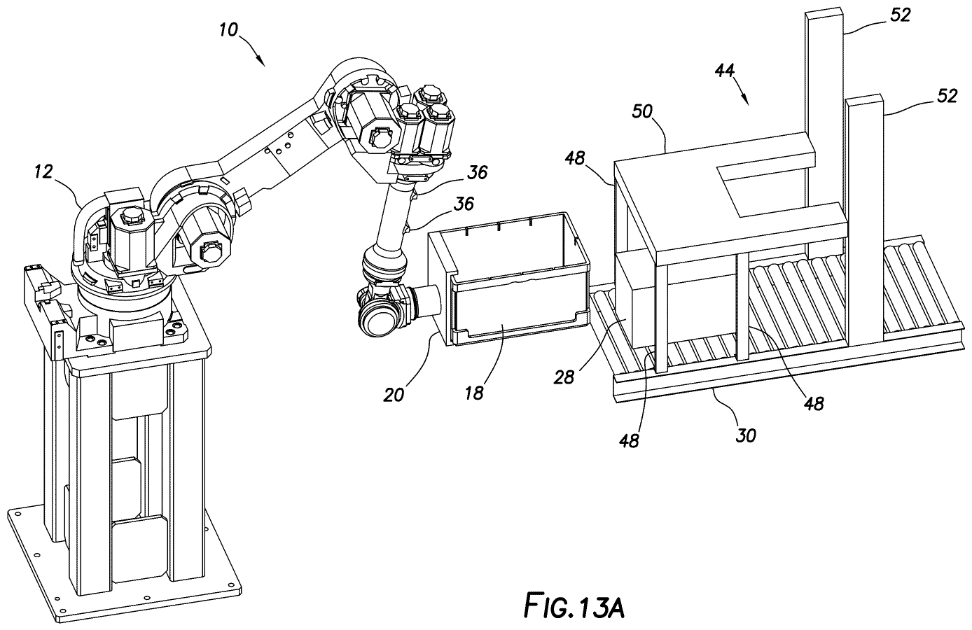

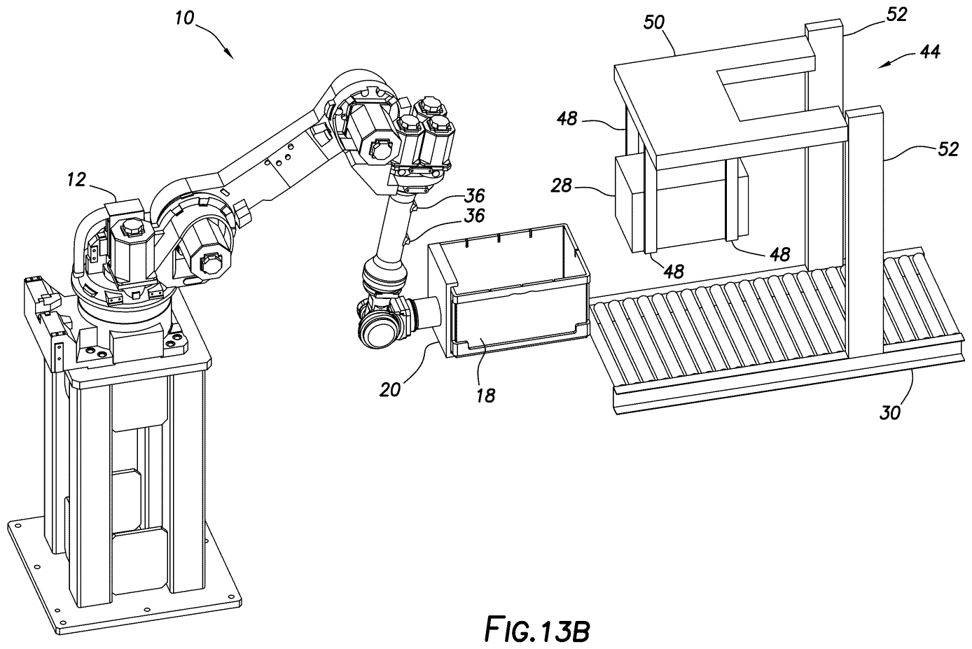

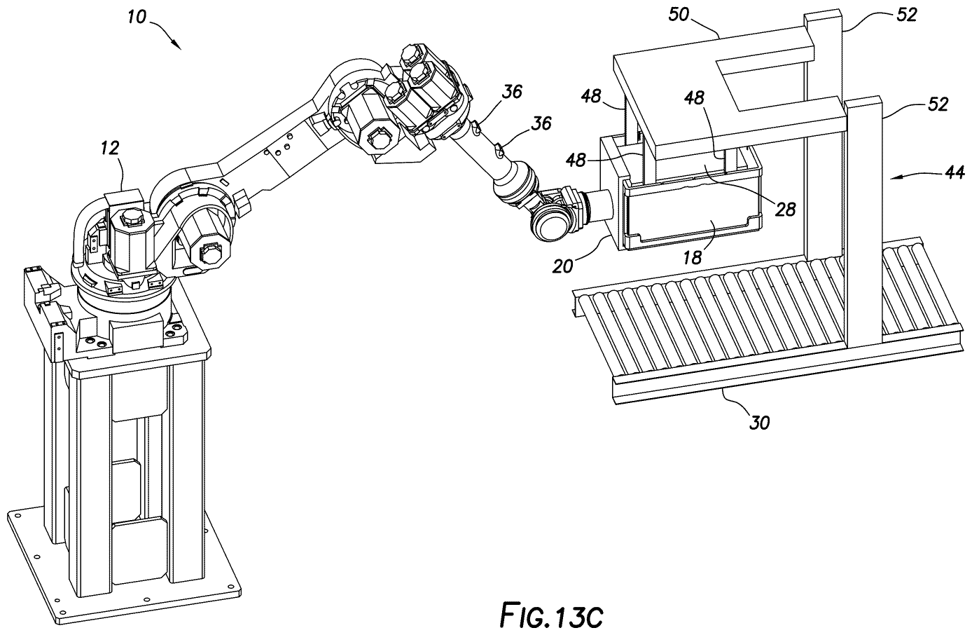

Referring additionally now to FIGS. 13A-C, representative perspective views of a series of steps performed by the tote handling robot 12 and the container picker 44 of the FIGS. 9 & 10 system 10 and method are depicted. In these views, the container is lifted from the conveyor 30 and placed in a tote 18 carried by the robot 12.

In FIG. 13A, the robot 12 is holding the tote 18, using the end of arm tool 20. The container 28 is positioned on the conveyor 30 under the carriage 50. The arms 48 are positioned spaced apart from opposite sides of the container 28.

In FIG. 13B, the distance between the arms 48 is decreased, so that the arms grip or hold the container 28. The carriage 50 is raised, so that the container 28 is lifted from the conveyor 30. The container 28 is raised to a position higher than the tote 18 in this example, so that the tote can be displaced under the container by the robot 12.

In FIG. 13C, the tote 18 is positioned under the container 28. The tote 18 is then raised, so that the container 28 is received in the interior of the tote. Alternatively, the carriage 50 could be lowered to place the container 28 into the interior of the tote 18. The width between the arms 48 can now be increased, in order to release the container 28 from the container picker 44 into the tote 18, and the tote can be transported by the robot 12 to another location (such as, to a rack 14 or conveyor 16).

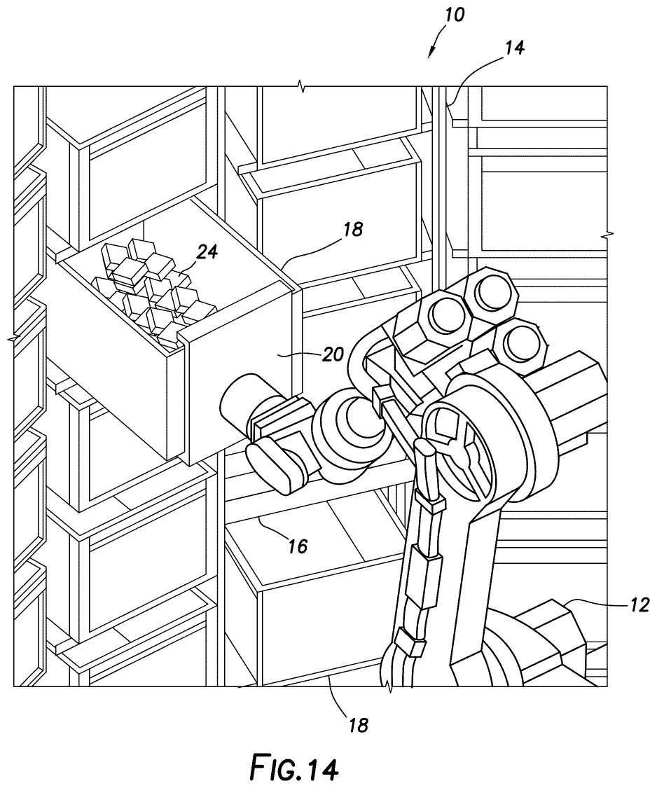

Referring additionally to FIG. 14, a representative perspective view of an example of the tote handling robot 12 storing or retrieving a tote 18 in or from a rack 14 is depicted. In this example, individual items 24 are contained in the tote 18, but in other examples one or more containers 28 (or a mixture of individual items and containers, e.g., in separate compartments) could be in the tote.

The robot 12 can hold the tote 18 while it transports the tote between locations in the system 10 (such as, between the hopper 22 and a rack 14, between positions in the racks, between the hopper and a conveyor 16, or between the rack and the conveyor). The end of arm tool 20 permits the robot 12 to hold the tote 18, in this example by supporting the tote from below.

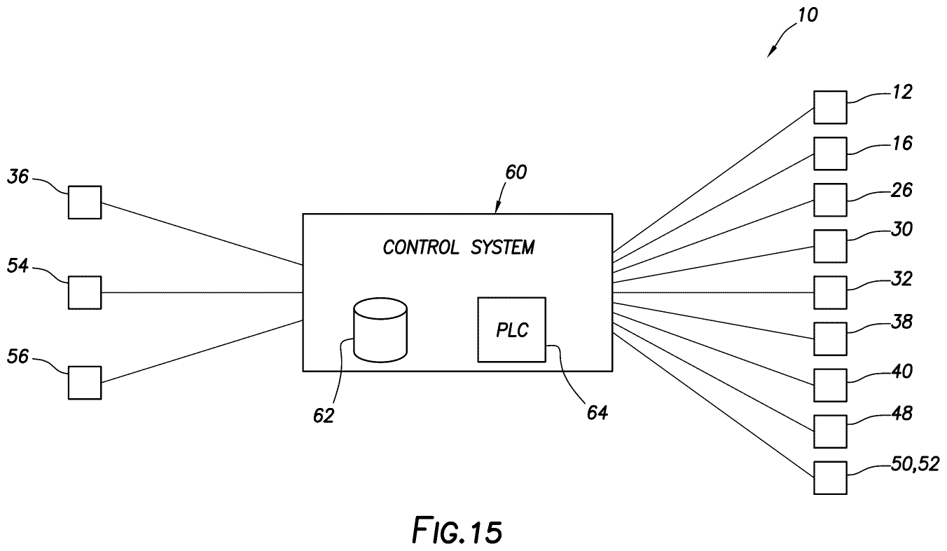

Referring additionally now to FIG. 15, a representative schematic view of an example of a control system 60 that may be used with any of the systems 10 and methods described herein is depicted. In this example, the control system 60 is used to control operation of various actuators of the system 10 in response to outputs of the sensors 36, 54, 56.

The actuators may be electrical, pneumatic, hydraulic or other type of actuators. As depicted in FIG. 15, the actuators are those used to operate the tote handling robot 12, the conveyors 16, the container handling robot 26, the conveyor 30, the end of arm tool 32, the walls 38, 40, the arms 48 and the carriage/rails 50, 52. Other actuators may be controlled using the control system 60 in other examples.

The control system 60 in the FIG. 15 example includes memory 62 and an integral programmable logic controller 64 for controlling operation of the actuators. The memory 62 can store programs or instructions for receiving the outputs of the sensors 36, 54, 56, evaluating the sensor outputs (such as, graphics processing routines for evaluating images or scans from the sensors), and determining how the actuators should be operated in response to the sensor outputs. The control system 60 can also include input and output devices (such as, a monitor, a keyboard, a pointing device, a printer, data communication devices, etc.), one or more processors, a power supply, or any other appropriate devices.

In one example, the memory 62 can store time-stamped records of the totes 18, items 24 and/or containers 28 handled by the system 10 (for example, so that the location of a particular tote, item or container can be readily determined). The sensors 54, 56 may comprise bar code or radio frequency identification (RFID) scanners for convenient product identification of the containers 28 handled by the system 10.

The control system 60 can be used to control the size of the opening 34 in the hopper 22 by adjusting the positions of the walls 38, 40. This adjustment is made in response to the outputs of the sensors 36, which scan the interior of the tote 18.

The control system 60 can then be used to operate the robot 12 to position the tote 18 (or a selected compartment of the tote) under the adjusted area opening 34. The control system 60 may select the tote 18 compartment out of multiple compartments in the tote if the tote compartment is indicated as being empty (or less than full) in a scan of the interior of the tote.

The control system 60 can be used to cause the robot 12 to position the tote 18 under the container 28 and the arms 48 of the container picker 44. The control system 60 can adjust the width between the arms 48 to match the container 28 width in response to a scan of the container by the sensor 54.

It may now be fully appreciated that the present disclosure provides significant advancements to the art of automated storage and retrieval systems. In examples described herein, items 24 and/or containers 28 can be efficiently deposited in totes 18 and transported to different locations in the system 10

The present disclosure provides to the art a tote content management system 10. In one example, the system 10 can comprise a first robot 12 configured to transport a tote 18 between locations in the system 10, and a hopper 22 having a variable area opening 34. The hopper 22 is configured to match the opening 34 to an area of a tote 18 compartment. The first robot 12 is further configured to place the tote 18 compartment under the hopper opening 34.

The tote 18 compartment may be one of multiple compartments in the tote 18. The locations may comprise a position under the hopper opening 34, and a position in a rack 14.

The first robot 12 may comprise a sensor 36 configured to scan an interior of the tote 18. The system 10 may include a control system 60 configured to adjust the opening 34 area in response to a scan of the interior of the tote 18. The control system 60 may be further configured to cause the first robot 12 to position the tote 18 compartment under the opening 34.

A control system 60 may be configured to select the tote 18 compartment out of multiple compartments in the tote 18 in response to the tote 18 compartment being empty in a scan of the interior of the tote 18.

The hopper 22 may comprise a movable wall 38, 40. The opening 34 may be partially bounded by the wall.

The system 10 may include a second robot 26 configured to transport a container 28 to a position above the hopper opening 34, and to release one or more items 24 from the container 28 into the hopper opening 34. The second robot 26 may be further configured to transport the container 28 from a conveyor 30 to the position above the hopper opening 34.

The system 10 may include a sensor 54 configured to scan a product identification on the container 28.

Another tote content management system 10 disclosed herein can comprise a robot 12 configured to transport a tote 18 between locations in the system 10, and a container picker 44 configured to pick up a container 28 and release the container 28 into a tote 18. The robot 12 may be further configured to transport the tote 18 between the container picker 44 and a rack 14.

The container picker 44 may include arms 48, a width between the arms 48 being variable to match a width of the container 28. The system 10 may include a control system 60 configured to cause the robot 12 to position the tote 18 under the arms 48 and the container 28.

The container picker 44 may include a sensor 54, 56 configured to scan the container 28. The system 10 may include a control system 60 configured to adjust the width between the arms 48 to match the container 28 width in response to the scan of the container 28.

The system 10 may include a conveyor 30 configured to position the container 28 proximate the arms 48.

The system 10 may include a sensor 56 configured to scan the container 28 in the tote 18.

The robot 12 may be configured to transport the tote 18 between the rack 14 and a conveyor 16.

The container picker 44 may include a sensor 54 configured to scan a product identification on the container 28.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A tote content management system, comprising:
a first robot configured to transport a tote between locations in the system; and
a hopper having a variable area opening, the hopper being configured to match the opening to an area of a tote compartment, and
in which the first robot is further configured to place the tote compartment under the hopper opening.

2. The system of claim 1, in which the tote compartment is one of multiple compartments in the tote.

3. The system of claim 1, in which the locations comprise a position under the hopper opening, and a position in a rack.

4. The system of claim 1, in which the first robot comprises a sensor configured to scan an interior of the tote.

5. The system of claim 4, further comprising a control system configured to adjust the opening area in response to a scan of the interior of the tote.

6. The system of claim 5, in which the control system is further configured to cause the first robot to position the tote compartment under the opening.

7. The system of claim 4, further comprising a control system configured to select the tote compartment out of multiple compartments in the tote in response to the tote compartment being empty in a scan of the interior of the tote.

8. The system of claim 1, in which the hopper comprises at least one movable wall, the opening being partially bounded by the wall.

9. The system of claim 1, further comprising a second robot configured to transport a container to a position above the hopper opening, and to release one or more items from the container into the hopper opening.

10. The system of claim 9, in which the second robot is further configured to transport the container from a conveyor to the position above the hopper opening.

11. The system of claim 1, further comprising a sensor configured to scan a product identification on the container.

12. A tote content management system, comprising:
a robot configured to transport a tote between locations in the system; and
a container picker configured to pick up a container and release the container into a tote, and
in which the robot is further configured to transport the tote between the container picker and a rack.

13. The system of claim 12, in which the container picker comprises arms, a width between the arms being variable to match a width of the container.

14. The system of claim 13, further comprising a control system configured to cause the robot to position the tote under the arms and the container.

15. The system of claim 13, in which the container picker further comprises a sensor configured to scan the container.

16. The system of claim 15, further comprising a control system configured to adjust the width between the arms to match the container width in response to the scan of the container.

17. The system of claim 12, further comprising a conveyor configured to position the container proximate the arms.

18. The system of claim 12, further comprising a sensor configured to scan the container in the tote.

19. The system of claim 12, in which the robot is further configured to transport the tote between the rack and a conveyor.

20. The system of claim 12, in which the container picker comprises a sensor configured to scan a product identification on the container.
